(19) United States
(12) Patent Application Publication
(10) Pub. No.: US 2021/0053333 A1
(43) Pub. Date: Feb. 25, 2021

(54) HIGH TEMPERATURE HYBRID COMPOSITE LAMINATES

(71) Applicant: United Technologies Corporation, Farmington, CT (US)

(72) Inventors: Scott Alan Eastman, Glastonbury, CT (US); Justin B. Alms, Coventry, CT (US); Xuemei Wang, South Windsor, CT (US)

(73) Assignee: United Technologies Corporation, Farmington, CT (US)

(21) Appl. No.: 16/545,368

(22) Filed: Aug. 20, 2019

(51) Int. Cl. B32B 33/00; B32B 3/12

(52) U.S. Cl. CPC B32B 33/00; B32B 3/12; B32B 2307/416; B32B 2603/00; B32B 2307/306; B32B 2305/022; B32B 2305/024

(57) ABSTRACT

A composite laminate comprising a substrate having a hot side and a cold side opposite said hot side; a thermal barrier coating coupled to said hot side of said substrate; and a reflective coating disposed on said thermal barrier coating.

### BACKGROUND

The present disclosure is directed to a composite laminate. More particularly polymer matrix composite substrates are provided with thermal barrier coating covered with a heat reflective coating.

A gas turbine engine includes a high-pressure spool, a combustion system, and a low-pressure spool disposed within an engine case to form a generally axial, serial flow path about an engine centerline. The high-pressure spool includes a high-pressure turbine, a high-pressure shaft extending axially forward from the high-pressure turbine, and a high-pressure compressor connected to a forward end of the high-pressure shaft. The low-pressure spool includes a low-pressure turbine disposed downstream of the high-pressure turbine, a low-pressure shaft, typically extending coaxially through the high-pressure shaft, and a low-pressure compressor connected to a forward end of the low-pressure shaft, forward of the high-pressure compressor. The combustion system is disposed between the high-pressure compressor and the high-pressure turbine and receives compressed air from the compressors and fuel provided by a fuel injection system. During the combustion process, compressed air is mixed with the fuel in a combustion chamber. The combustion process produces high-energy gases to produce thrust and turn the high- and low-pressure turbines, driving the compressors to sustain the combustion process.

The trend of new aerospace platforms desiring continually higher use temperatures, current polymer matrix composites (PMC) are beginning to reach their limits due to use temperature. Higher temperature metal matrix composites (MMC) and ceramic matrix composites (CMC) can provide higher use temperatures but at a penalty to weight and/or durability. A hybrid composite approach would enable an extension of PMC use temperature while limiting the weight increase of these materials.

### SUMMARY

In accordance with the present disclosure, there is provided a composite laminate comprising a substrate having a hot side and a cold side opposite the hot side; a thermal barrier coating coupled to the hot side of the substrate; and a reflective coating disposed on the thermal barrier coating.

In another and alternative embodiment, the composite laminate further comprises an air flow layer coupled to the substrate on the cold side.

In another and alternative embodiment, the air flow layer comprises at least one of a honeycomb and an open cell foam material.

In another and alternative embodiment, the air flow layer comprises flow channels configured to flow cooling air.

In another and alternative embodiment, the composite laminate further comprises an additional composite layer coupled to the air flow layer opposite the substrate, the additional composite layer comprises perforations that fluidly communicate with the flow channels of the air flow layer, wherein the perforations are configured to flow cooling fluid.

In another and alternative embodiment, the thermal barrier layer comprises at least one layer.

In another and alternative embodiment, the thermal barrier layer comprises a preform sheet.

In accordance with the present disclosure, there is provided a composite laminate cooling flow duct for a gas turbine engine comprising a substrate forming the duct, the substrate having a hot side and a cold side opposite the hot side; a thermal barrier coating coupled to the hot side of the substrate; a reflective coating disposed on the thermal barrier coating; an air flow layer coupled to the substrate on the cold side; and an additional composite layer coupled to the air flow layer opposite the substrate, the additional composite layer comprises perforations that fluidly communicate with the air flow layer, wherein the perforations are configured to flow cooling fluid.

In another and alternative embodiment, the air flow layer comprises flow channels configured to flow cooling air.

In another and alternative embodiment, the air flow layer comprises at least one of a honeycomb and an open cell foam material.

In another and alternative embodiment, the reflective coating comprises a conformal inorganic coating in a single layer.

In another and alternative embodiment, the air flow layer comprises a carbon reinforced composite with milled air flow channels.

In another and alternative embodiment, the reflective coating can include a thickness of from 5 nanometers-5000 nanometers.

In accordance with the present disclosure, there is provided a process for protecting a composite laminate cooling flow duct for a gas turbine engine comprising forming the duct from a substrate, the substrate having a hot side and a cold side opposite the hot side; coating the substrate with a thermal barrier coating coupled to the hot side of the substrate; coating the thermal barrier coating with a reflective coating opposite the substrate; coupling an air flow layer to the substrate on the cold side; and coupling an additional composite layer to the air flow layer opposite the substrate, the additional composite layer comprises perforations that fluidly communicate with the air flow layer, wherein the perforations are configured to flow cooling fluid.

In another and alternative embodiment, the reflective coating comprises a conformal inorganic coating in a single layer.

In another and alternative embodiment, the reflective coating comprises a double layer comprising a conformal metal layer capped with a conformal inorganic coating.

In another and alternative embodiment, the metal layer comprises dimensions ranging from 50 nanometers to 1000 nanometers.

In another and alternative embodiment, the thermal barrier coating comprises a matrix of materials formed from ultra-high inorganic materials including a filler material held together with binder.

In another and alternative embodiment, the air flow layer comprises flow channels configured to flow cooling air.

In another and alternative embodiment, the air flow layer comprises at least one of a honeycomb and an open cell foam material.

Other details of the composite laminate are set forth in the following detailed description and the accompanying drawings wherein like reference numerals depict like elements.

### BRIEF DESCRIPTION OF THE DRAWINGS

FIG. 1 is a simplified cross-sectional view of a gas turbine engine.

FIG. 2 is a cross-sectional view of an exemplary composite laminate.

FIG. 3 is a cross-sectional view of an exemplary composite laminate.

### DETAILED DESCRIPTION

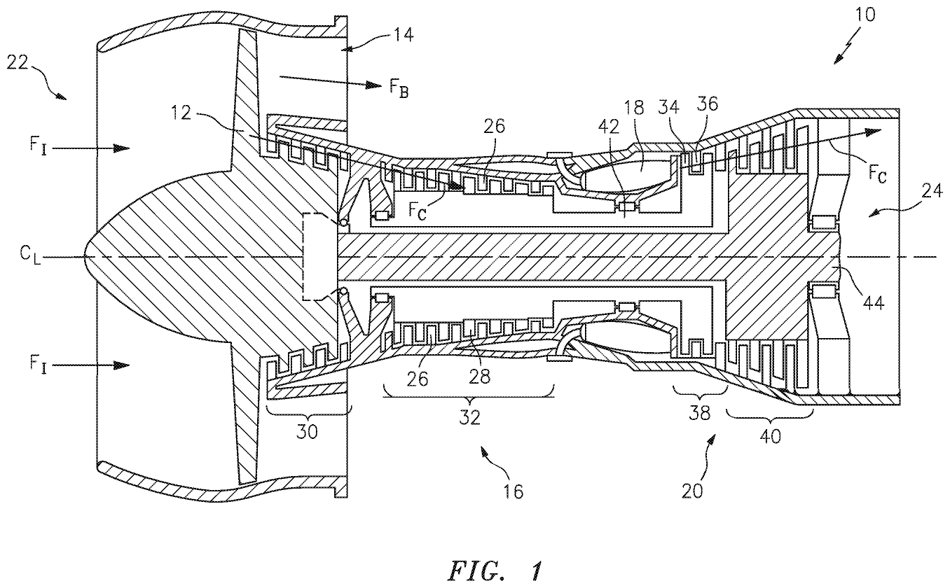

FIG. 1 is a simplified cross-sectional view of a gas turbine engine 10 in accordance with embodiments of the present disclosure. Turbine engine 10 includes fan 12 positioned in bypass duct 14. Turbine engine 10 also includes compressor section 16, combustor (or combustors) 18, and turbine section 20 arranged in a flow series with upstream inlet 22 and downstream exhaust 24. During the operation of turbine engine 10, incoming airflow F₁ enters inlet 22 and divides into core flow F_{C} and bypass flow F_{B}, downstream of fan 12. Core flow F_{C} continues along the core flowpath through compressor section 16, combustor 18, and turbine section 20, and bypass flow F_{B} proceeds along the bypass flowpath through bypass duct 14.

Compressor 16 includes stages of compressor vanes 26 and blades 28 arranged in low pressure compressor (LPC) section 30 and high pressure compressor (HPC) section 32. Turbine section 20 includes stages of turbine vanes 34 and turbine blades 36 arranged in high pressure turbine (HPT) section 38 and low pressure turbine (LPT) section 40. HPT section 38 is coupled to HPC section 32 via HPT shaft 42, forming the high pressure spool. LPT section 40 is coupled to LPC section 30 and fan 12 via LPT shaft 44, forming the low pressure spool. HPT shaft 42 and LPT shaft 44 are typically coaxially mounted, with the high and low pressure spools independently rotating about turbine axis (centerline) C_{L}.

Combustion gas exits combustor 18 and enters HPT section 38 of turbine 20, encountering turbine vanes 34 and turbines blades 36. Turbine vanes 34 turn and accelerate the flow of combustion gas, and turbine blades 36 generate lift for conversion to rotational energy via HPT shaft 42, driving HPC section 32 of compressor 16. Partially expanded combustion gas flows from HPT section 38 to LPT section 40, driving LPC section 30 and fan 12 via LPT shaft 44. Exhaust flow exits LPT section 40 and turbine engine 10 via exhaust nozzle 24. In this manner, the thermodynamic efficiency of turbine engine 10 is tied to the overall pressure ratio (OPR), as defined between the delivery pressure at inlet 22 and the compressed air pressure entering combustor 18 from compressor section 16. As discussed above, a higher OPR offers increased efficiency and improved performance. It will be appreciated that various other types of turbine engines can be used in accordance with the embodiments of the present disclosure.

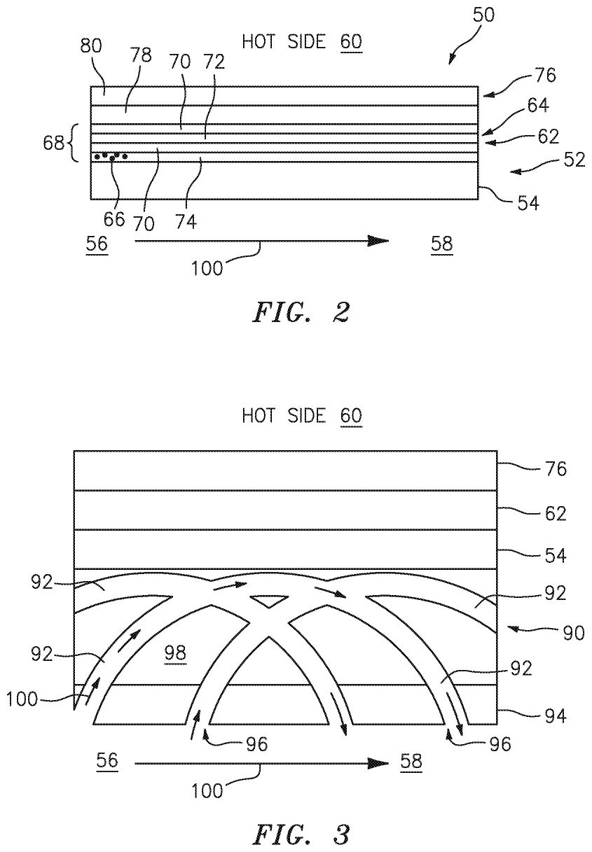

FIG. 2 is a simplified cross-sectional view of an exemplary composite laminate 50. The composite laminate 50 includes a composite layer 52. The composite layer 52 can be a substrate 54 that forms the structure within a fluid passage or air flow ducting 56. The composite laminate 50 has a cold side 58 and a hot side 60 opposite the cold side 58. In an exemplary embodiment, the difference in temperature between the cold side 58 and the hot side 60 can be greater than 100 degrees Fahrenheit. The substrate 54 can form a portion of the duct 56. The substrate 54 can be a high temperature (>300° F.) air flow ducting for aerospace use. The substrate 54 can comprise a polymer ducting made from thermoplastics such as (polyether ether ketone) PEEK, (polyether ketone ketone) PEKK (polyaryl ether ketone) PAEK, polyetherimides such as Ultem™, polyphenylene sulfide, and composites thereof. The substrate 54 can comprise a thermoset composite ducting that is made from fiber reinforced epoxy, polyimide and phthalonitrile, or bismaleimide composite. In another exemplary embodiment, the composite laminate 50 can comprise a polymer matrix material, a metal matrix material, and/or a ceramic matrix material.

A thermal barrier coating 62 is coupled to the substrate 54 proximate the hot side 60 and opposite the cold side 58. The thermal barrier coating 62 can comprise a matrix of materials 64. The thermal barrier coating 62 matrix of materials 64 can be formed from ultra-high inorganic materials held together with binder (>75% inorganic content in as formed coating). In an exemplary embodiment the matrix material 64 can include filler 66. It is desired to include filler 66 with a low bulk thermal conductivity (W/mK). In an exemplary embodiment the low bulk thermal conductivity can be ≤0.5 W/mK and more specifically ≤0.3 W/mK and more specifically ≤0.1 W/mK. Bulk thermal conductivity is derived from measurements on the filler powder itself as conductivities of individual filler grains is very difficult. In another exemplary embodiment, the filler 66 can be a nanoscale material in at least one direction from 1-500 nm per particle. The nanoscale material can have a high aspect ratio ranging from 2-5000, more specifically 10-2500 and more specifically 100-2000. This high aspect ratio can be in relation to 1 or both orthogonal axis to the thickness of the filler resulting in either 1-D (rods/tubes) or 2-D (platelets). The filler 66 can promote oxidative protection by acting as a oxygen barrier to the underlying substrate as well as a gaseous barrier of volatile degradation products from the substrate out to the hot side and dissociation of hot spots. In an exemplary embodiment, the filler 66 can include clay, such as montmorillonite; micas, such as, vermiculite; metal oxides; metal nitrides; and the like.

The thermal barrier coating 62 can be applied sequentially (layer-by-layer) or applied in a single pass coating.

In an exemplary embodiment, layers 68 of highly inorganic platelet layers 70 can be separated by layers of highly inorganic spherical particulate or hollow nanospheres 72 (example of hollow nanospheres

The matrix material 64 can include a binder 74. The binder 74 can be water soluble polymer that has good interaction with the filler 66. In an exemplary embodiment, the binder can include polyvinyl alcohol, polyetherimid, poly (N-isopropylacrylamide).

The matrix material 64 can include a binder 74. The binder 74 can be solvent soluble polymer that has good interaction with the filler 66. In an exemplary embodiment, the binder can include polyurethane, polychloroprene, and polytetrafluoroethylene.

A reflective coating 76 is coupled to the thermal barrier coating 62. The reflective coating 76 can include a conformal inorganic coating in a single layer. The reflective coating can include aluminum oxide, hafnium oxide, tin nitride, silicon oxide, silicon carbide, and the like. The reflective coating 76 can include a layer thickness of from 5 nanometers-5000 nanometers. In another exemplary embodiment, the layer thickness can be from 500 nanometers-2000 nanometers. The reflective coating 76 can be applied by using vapor deposition coating to provide a conformal coat. Examples of coating techniques can include chemical vapor deposition, atomic layer deposition, and the like.

In another exemplary embodiment, the reflective coating 76 can comprise a conformal metal layer 78 capped with conformal inorganic coating 80 in a double layer for added infrared (IR) reflectivity. The metal reflective layer 78 can be any deposited metal. In exemplary embodiments, metal can be inert metal with examples including nickel, chrome, silver, gold, platinum and the like. The metal layer 78 can be very thin with dimensions ranging from 50 nanometers to 1000 nanometers. The capped inorganic coating 80 of this configuration can comprise similar materials as the reflective coating 76 described above.

The reflective coating 76 can withstand the thermal, oxidative, and abrasive environment of elevated temperature ducting in aerospace applications. The reflective layer 76 can reflect IR heat away from the cold side 58 duct 82 to reduce thermal load through the substrate 54 wall of the duct 56. In addition the reflective coating 76 can provide some mechanical durability/life extension to the underlying thermal barrier coating 62 as well as fill any surface porosity that may exist in the thermal barrier coating 62.

In another exemplary embodiment shown at FIG. 3, the composite substrate 54 can be coupled to an air flow layer 90. The air flow layer 90 is coupled to the composite substrate 54 opposite the thermal barrier coating 62. The air flow layer 90 can comprise a honeycomb and/or open cell foam material. The open cell material can include flow channels 92. In an alternative embodiment, the open cell foam material be configured to flow air without the flow channels 92.

An additional composite layer 94, can be coupled to the airflow layer 90 on an opposite side from the composite substrate 54, such that there is a hot side composite substrate 54 and a cold side composite layer 94 in the composite laminate 50. The composite layer 94 can include perforations 96 that fluidly communicate with the flow channels 92 of the air flow layer 90 and are configured to flow cooling fluid 98. The additional composite layer 94 can comprise a polymer matrix material. The additional composite layer 94 can comprise a polymer from thermoplastics such as (polyether ether ketone) PEEK, (polyether ketone ketone) PEKK (polyaryl ether ketone) PAEK, polyetherimides such as Ultem™, polyphenylene sulfide, and composites thereof.

In another exemplary embodiment, the air flow layer 90 can include a carbon reinforced composite with milled air flow channels 92.

The flow channels 92 and/or the open cell materials 98 can be configured to flow air 100 that can remove thermal energy from the substrate 54. The cooling air 100 can be supplied from the duct 56 and flow through the flow channels 92.

A technical advantage of the composite laminate includes the capacity to extend the operational temperature of the polymer matrix composites while minimizing the weight increase needed to improve the operational temperature.

There has been provided a composite laminate. While the composite laminate has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A composite laminate comprising:
a substrate having a hot side and a cold side opposite said hot side;
a thermal barrier coating coupled to said hot side of said substrate; and
a reflective coating disposed on said thermal barrier coating.

2. The composite laminate according to claim 1, further comprising:
an air flow layer coupled to said substrate on said cold side.

3. The composite laminate according to claim 2, wherein said air flow layer comprises at least one of a honeycomb and an open cell foam material.

4. The composite laminate according to claim 3, wherein said air flow layer comprises flow channels configured to flow cooling air.

5. The composite laminate according to claim 4, further comprising:
an additional composite layer coupled to said air flow layer opposite said substrate, said additional composite layer comprises perforations that fluidly communicate with the flow channels of the air flow layer, wherein said perforations are configured to flow cooling fluid.

6. The composite laminate according to claim 1, wherein said thermal barrier layer comprises at least one layer.

7. The composite laminate according to claim 1, wherein said thermal barrier layer comprises a preform sheet.

8. A composite laminate cooling flow duct for a gas turbine engine comprising:
a substrate forming said duct, said substrate having a hot side and a cold side opposite said hot side;
a thermal barrier coating coupled to said hot side of said substrate;
a reflective coating disposed on said thermal barrier coating;
an air flow layer coupled to said substrate on said cold side; and
an additional composite layer coupled to said air flow layer opposite said substrate, said additional composite layer comprises perforations that fluidly communicate with the air flow layer, wherein said perforations are configured to flow cooling fluid.

9. The according to claim 8, wherein said air flow layer comprises flow channels configured to flow cooling air.

10. The according to claim 8, wherein said air flow layer comprises at least one of a honeycomb and an open cell foam material.

11. The according to claim 8, wherein the reflective coating comprises a conformal inorganic coating in a single layer.

12. The according to claim 8, wherein said air flow layer comprises a carbon reinforced composite with milled air flow channels.

13. The according to claim 8, wherein the reflective coating can include a thickness of from 5 nanometers-5000 nanometers.

14. A process for protecting a composite laminate cooling flow duct for a gas turbine engine comprising:
forming said duct from a substrate, said substrate having a hot side and a cold side opposite said hot side;
coating said substrate with a thermal barrier coating coupled to said hot side of said substrate;
coating said thermal barrier coating with a reflective coating opposite said substrate;
coupling an air flow layer to said substrate on said cold side; and
coupling an additional composite layer to said air flow layer opposite said substrate, said additional composite layer comprises perforations that fluidly communicate with the air flow layer, wherein said perforations are configured to flow cooling fluid.

15. The process of claim 14, wherein said reflective coating comprises a conformal inorganic coating in a single layer.

16. The process of claim 14, wherein said reflective coating comprises a double layer comprising a conformal metal layer capped with a conformal inorganic coating.

17. The process of claim 14, wherein said metal layer comprises dimensions ranging from 50 nanometers to 1000 nanometers.

18. The process of claim 14, wherein said thermal barrier coating comprises a matrix of materials formed from ultra-high inorganic materials including a filler material held together with binder.

19. The process of claim 14, wherein said air flow layer comprises flow channels configured to flow cooling air.

20. The process of claim 14, wherein said air flow layer comprises at least one of a honeycomb and an open cell foam material.
